(19) United States
(12) Patent Application Publication
(10) Pub. No.: US 2009/0210928 A1
(43) Pub. Date: Aug. 20, 2009

(54) METHOD AND A SYSTEM FOR MANAGING A USER RELATED ACCOUNT INFORMATION ASSOCIATED WITH APPLICATION SERVICES DISTRIBUTED OVER A DATA NETWORK

(76) Inventor: Jean Dobey Ourega, Verdun (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 12/032,223

(22) Filed: Feb. 15, 2008

(51) Int. Cl. G06F 7/04

(52) U.S. Cl. 726/4

(57) ABSTRACT

There is provided a method for managing a user related accounts, the method comprising: receiving user account information for use in connection with at least one application service associated with the user for which a user account management is required; receiving node identification information allowing for identifying at least one application node distributed over a data network, where the at least one application node stores the at least one application service; using the received node identification information for delivering to the at least one application node, through the data network, the user account information; and instead of requiring from the user any manual procedures, automatically processing, at the at least one application node, the delivered user account information, where the processing comprises, in connection with each one of the at least one application service, creating or accessing and updating a corresponding user account using the received user account information. There is further provided a system for managing a user related accounts associated with application services distributed over a data network.

### FIELD OF THE INVENTION

The present invention relates generally to the field of electronic communications, and more specifically to a method and a system for managing a user related account information associated with application services distributed over a data network.

### BACKGROUND OF THE INVENTION

The volume of application services distributed over the digital data networks (such as the Internet and the mobile phone networks) is increasing exponentially in our days. A big part of the application services require, from the users, creating a user account and updating it regularly.

In our days, each single user might have a plurality of application services and he might need to update his user account information (such as user profile) several times during a given period of time.

Traditionally, the user had to access manually and distinctly each one of the application services for updating the user account information stored therein. With the huge volume of application services in our days, this operation is too much time consuming and security compromising for the users.

### SUMMARY OF THE INVENTION

It is therefore an object of the present invention to provide a method and a system for managing a user related account information associated with application services distributed over a data network that overcome the above drawbacks.

As a first aspect of the invention there is provided a method for managing a user related account information, the method comprising:
receiving user account information for use in connection with at least one application service associated with the user for which a user account management is required;
receiving node identification information allowing for identifying at least one application node distributed over a data network, where the at least one application node stores the at least one application service;
using the received node identification information for delivering to the at least one application node, through the data network, the user account information; and
instead of requiring from the user any manual procedures, automatically processing, at the at least one application node, the delivered user account information, where the processing comprises, in connection with each one of the at least one application service, creating or accessing and updating a corresponding user account using the received user account information.

The method preferably further comprises authenticating the user before processing the received user account information.

The authenticating preferably comprises transmitting an authentication request to the user and receiving a positive authentication response thereof before carrying out the processing.

The authenticating can be carried out using a remote phone call instead of requiring manual authentication procedures.

The method preferably further comprises notifying the user if the processing has been carried out successfully.

The notifying can be carried out using a remote phone call.

The at lest one application service can comprise at least one user login protected application service, the received user account information can comprise login information associated therewith, and the creating or accessing a corresponding user account can be carried out using the login information.

The login information can comprise a corresponding user name and password of the user for each one of the at least one login protected application service.

The user account information can comprise user profile information comprising at least one of contact information and wallet information associated with the user.

The data network preferably comprises the Internet.

The application services preferably comprise Web application services, and the application nodes preferably comprise application servers connected to the Internet storing the Web application services.

The Web application services can comprise user login protected Web application services, the provided user account information can comprise login information associated with the login protected Web application services, and the creating or accessing a corresponding user account can be carried out using the login information, where the login information can comprises a corresponding user name and password of the user for each one of the login protected Web application services and the user account information comprises user profile information.

The node identification information can comprise domain names associated with the Web application services.

The user account information is preferably stored in a user account information database connected to the Internet from which the user account information is delivered to the at least one application node.

Preferably, the user account information database is locally connected to a user terminal associated with the user, the received node identification information is specified by the user, and the delivering the user account information to the at least one application node is initiated by the user using the user terminal.

The user terminal can de a computer terminal connected to the Internet.

The network preferably further comprises a mobile phone network, and the user terminal is a mobile phone connected to the mobile phone network and to the Internet.

The method preferably further comprises authenticating the user before processing the delivered user account information and notifying the user if the processing has been carried out successfully.

The authenticating and the notifying can be carried out using a remote phone call.

The authenticating can comprise tracking, by the at least one application node, an identity of the mobile phone from which the delivering has been initiated and comparing the tracked mobile phone identity to an authentic mobile phone identity of the user.

The mobile phone identity can be a mobile phone number.

The user account information database can be comprised in a server connected to the Internet and geographically distant from the user.

The delivering the user account information to the at least one application node can be initiated by an upload triggering module located in the server.

The delivering the user account information to the at least one application node can be initiated by a download triggering module located at the at least one application node.

The delivering can be initiated by the download triggering module after receiving a download signal from the user inviting for downloading the user account information from the user account information database.

The download signal can comprise information allowing for locating the user account information database over the Internet.

The information allowing for locating the user account database over the Internet can be an IP address of the database.

The data network can comprises a mobile phone network, the application services comprise mobile application services, and the application nodes comprise mobile phone devices storing the mobile application services.

The node identification information can comprise phone numbers of the mobile phone devices storing the mobile application services.

As a second aspect of the invention, there is provided a system for managing a user related account information, the system comprising:
an information receiving module for receiving node identification information allowing for identifying at least one application node storing at least one application service for which a user account management is required, and for receiving user account information in connection with the at least one application service;
a user account information database for storing the received user account information;
a data transmission unit adapted to be connected to the user account information database and to the network for delivering through the data network the user account information to the at least one application node storing the at least one application service; and
a user account management module for distribution and application at various application nodes comprising the at least one application node, for enabling the application nodes to acquire and automatically process the user account information instead of requiring any manual procedures by the user, where the processing comprises, for each one of the at least one application service, creating or accessing and updating a corresponding user account using the user account information.

The data network preferably comprises a mobile phone network, the application services comprise mobile application services, and the application nodes comprise mobile phone devices connected to the mobile network.

The data network preferably comprises the Internet.

The application services preferably comprise Web application services, and the application nodes comprise application servers connected to the Internet storing the Web application services.

The Web application services can comprise user login protected Web application services, the provided user account information can comprise login information associated with the login protected Web application services, and the creating or accessing a corresponding user account can be carried out using the login information, where the login information comprises a corresponding user name and password of the user for each one of the login protected Web application services and the user account information comprises user profile information comprising at least one of contact information and wallet information associated with the user.

The system preferably further comprises a data transmission triggering module for initiating the delivering of the user account information from the user account information database to the at least one application node.

Preferably, the information receiving module, the data transmission triggering module, the data transmission unit and the user account information database are locally connected to a user terminal associated with the user, and the delivering the user account information to the at least one application node is initiated by the user using the data transmission triggering module.

The user terminal can be a computer terminal connected to the Internet.

The data network preferably further comprises a mobile phone network, and the user terminal is a mobile phone connected to the mobile phone network and to the Internet.

The system preferably further comprises an authentication module for authenticating the user before processing the delivered user account information.

The system preferably further comprises a notification module for transmitting a notification signal to the user indicating if the processing has been carried out successfully.

Preferably, the authentication module is adapted to be connected to the data network for transmitting an authentication request to the user for validating the processing, the authentication module being adapted to receive an authentication request response from the user.

The authentication can be carried out using a remote phone call.

The authenticating preferably comprises tracking an identity of the mobile phone from which the delivering has been initiated and comparing the tracked mobile phone identity to an authentic mobile phone identity of the user.

The mobile phone identity can be a mobile phone number.

The system preferably further comprises a user account management server geographically distant from the user and connected to the Internet, wherein the data transmission unit and the user account information database are connected to the server.

Preferably, the user account management server comprises an upload triggering module for initiating the delivering and a user account information uploading module for uploading the user account information stored in the user account information database to the at least one application node.

The upload triggering module is preferably connected to a triggering rule database storing predefined triggering rules according to which the initiating is carried out.

Preferably, the delivering the user account information to the at least one application node is initiated at the node level by a download triggering module connected to download request transmitting module located in the at least one application node.

The delivering is preferably initiated by the download triggering module after receiving a download signal from the user inviting to download the user account information from the user account information database.

The download signal transmitted by the user preferably comprises information allowing for locating the user account information database over the Internet.

The information allowing for locating the user account management server over the Internet can be an IP address of the server.

The login information can comprise a corresponding user name and password of the user for each one of the login protected application services.

The user account information can comprises user profile information comprising at least one of contact information and wallet information associated with the user.

### BRIEF DESCRIPTION OF THE DRAWINGS

Further features and advantages of the present invention will become apparent from the following detailed description, taken in combination with the appended drawings, in which:

FIG. 1 is a flow chart showing a method for managing a user related account information associated with application services distributed over a data network;

FIG. 2 is a block diagram showing a data network topology in accordance with the present invention;

FIG. 3 is a block diagram showing, at the user terminal level, a system for managing a user related account information in accordance with the present invention;

FIG. 4 is a block diagram showing, at the user account management server level, a system for managing a user related account information in accordance with the present invention;

FIG. 5 is a block diagram showing, at the application nodes level, a system for managing a user related account information in accordance with the present invention; and

FIG. 6 is a chart of sequential events of that can be involved according to a first embodiment of managing a user related account information associated with application services distributed over a data network.

### DETAILED DESCRIPTION OF THE INVENTION

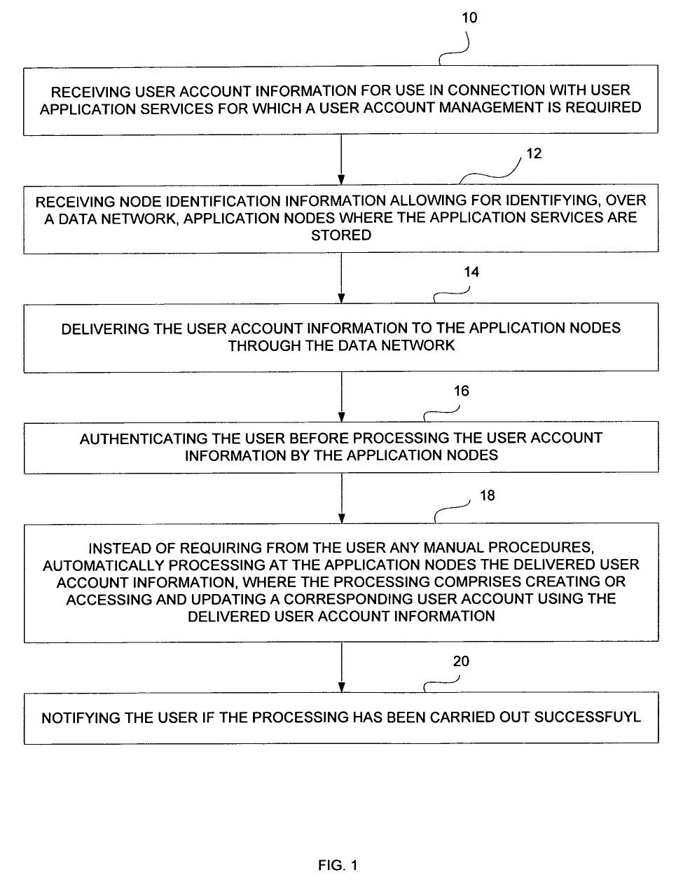

Referring to FIG. 1, there is provided a method for managing a user related account information associated with application services distributed over a data network.

The first step of the method consists of receiving user account information for use in connection with at least one application service associated with the user for which a user account management is required 10 (see FIG. 1).

The user account information normally comprises user profile information comprising contact information (such as civil address, email address, phone number, etc.) and wallet information (such as credit card number, social security number, etc.) associated with the user.

The user account information could be general or specific. The user account information is general when the same information is dedicated to all the application services. The user account information is specific when different information is dedicated to the different application services.

Then, the second step of the method consists of receiving node identification information allowing for identifying, over a data network 60, at least one application node 180 where the at least one application service is stored 12 (see FIG. 1).

The data network 60 can comprise any digital network where the application services are distributed. In the preferred embodiment, the data network 60 comprises the Internet and a mobile phone network connected thereto. In this last case, the application nodes 180 distributed over the network 60 consist of Web servers and mobile devices, respectively connected to the Internet and to the mobile phone network.

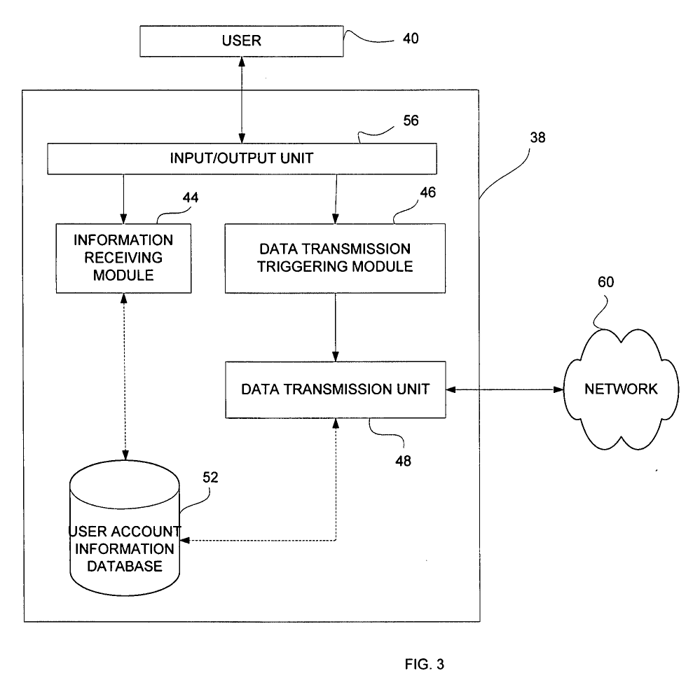

The user account information and node identification information are preferably specified by the user 40 using an input/output unit 56 and are transmitted to an information receiving module 44 that receives the information and stores it in a user account management database 52 before it is transmitted to a data transmission unit 48 connected to the data network 60 (see FIG. 3).

The user terminal 38 can be any terminal adapted to be connected to the data network 60 and capable of storing and transmitting data, such as a computer terminal, a mobile phone or any other communication device.

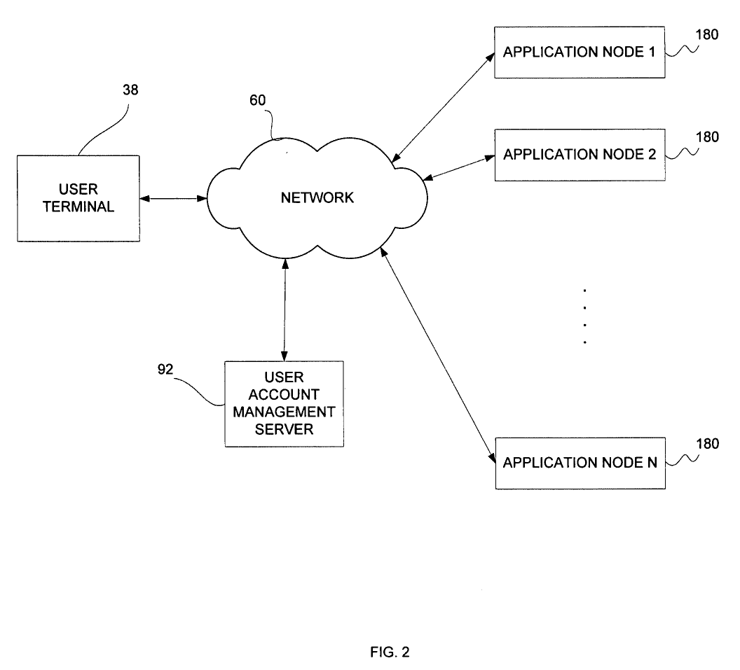

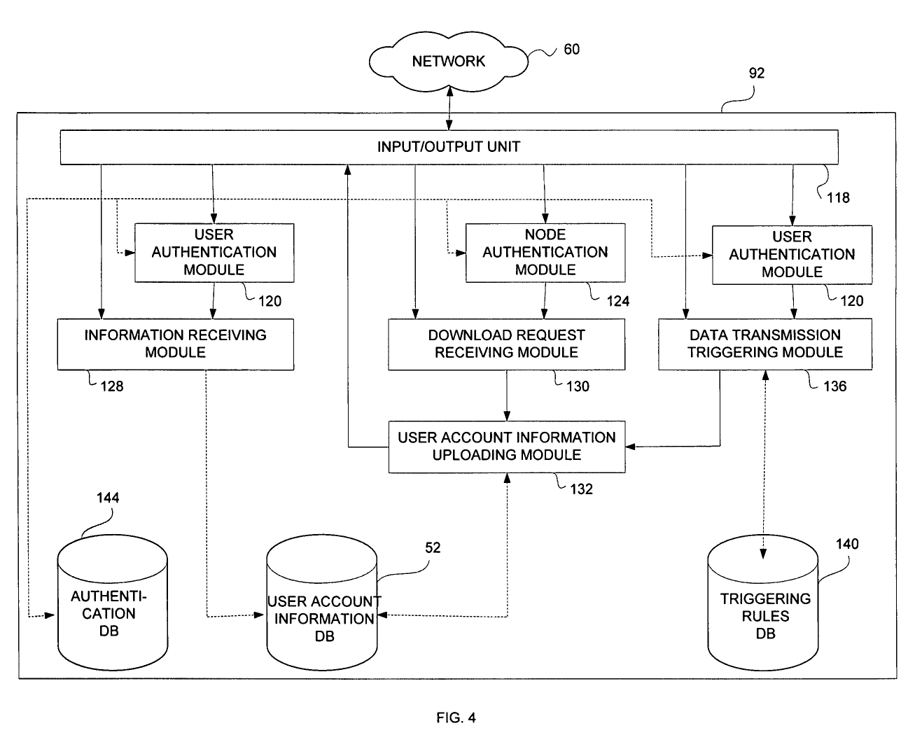

According to a second embodiment of the invention (see FIG. 2 and FIG. 4), the user account information database 96 is geographically distant from the user 40 and is connected to a user account management server 92 connected to the data network 60 (see FIG. 2 and FIG. 4). In this case, the user account information received by the information receiving module 44 is rather transmitted through the network to the user account management server 92 for storage.

Once the user account information and the node identification information are received and stored, the third step of the method consists of delivering the user account information to the application nodes 180 using the data network 14 (see FIG. 1). The delivering step can be initiated by different entities.

According to a first embodiment of the invention, it is the user himself 40 who manually initiates the delivering of the user account information to the application nodes 180. In other words, it is the user 40 who manually triggers (or gives the order for) the transmission of the user account information from the user account information database 52 to the application nodes 180.

This first embodiment is preferably incorporated when the user account information database 52 is locally connected to the user terminal 38 (see FIG. 3). In this case, the user 40 transmits a triggering signal, via the input/output unit 56 comprised in the user terminal 38, to the data transmission triggering module 46. The latter intercepts the triggering signal and sends an order to the data transmission unit 48 for extracting the appropriate user account information from the user account information database 52 and transmitting it to the application nodes 180.

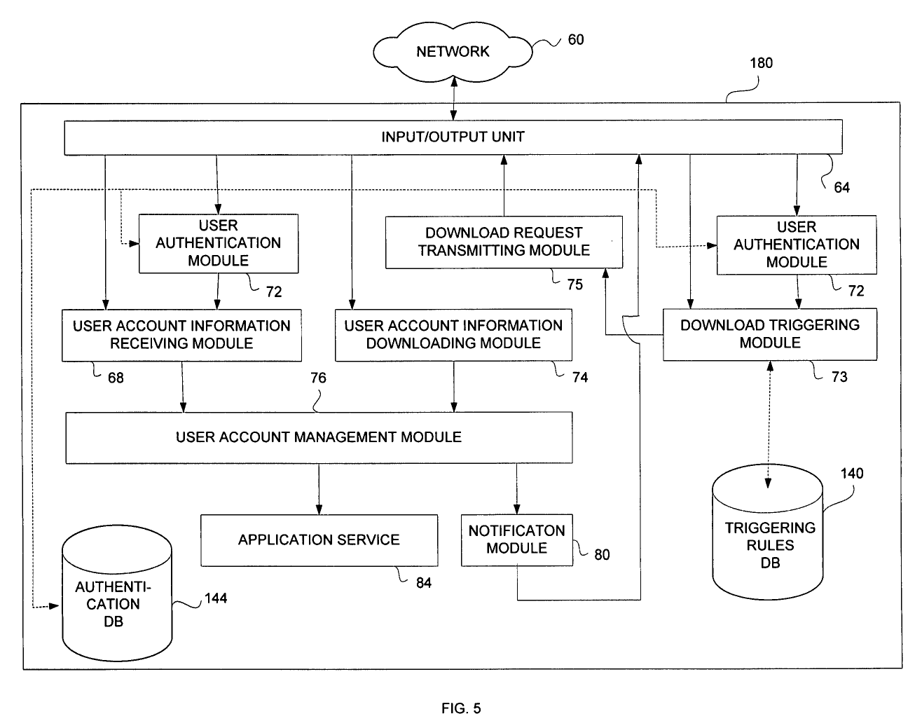

The transmitted data is received at the application nodes 180 by a user account information receiving module 68 running thereon. The latter receives the user account information and transmits it to the user account management module 76 for processing. As it will be illustrated hereinafter, the user 40 should be previously authenticated by the application node 180. The authentication process is carried out using a user authentication module 72 connected to an authentication database 144 and to the data network 60 (via an input/output unit 64) (see FIG. 5).

This first embodiment can also be incorporated when the user account information database 52 is geographically distant from the user 40 and is connected to the user account management server 92 (see FIG. 2 and FIG. 4). In this case, the delivering action can still be initiated by the user 40, but it is carried out remotely, at the application node level 180, through the data network 60.

According to this embodiment the user 40 transmits, through the data network 60, a download triggering signal to the different application nodes 180 inviting it to download the user account information from the user account information database 52. This download triggering signal is, for example, sent by the user 40 after he updates his user account information in the user account information database 52. According to this example, this download triggering signal informs the application nodes 180 that the user account information related to that given user has been updated and invites it to download the updated information from the user account information database 52 where it is stored.

The main advantage of this second implementation where the user account information is downloaded by the application nodes rather then is transmitted directly by the user resides in the fact that the user is dispensed from transmitting huge amounts of data from his terminal. This results in an important band width saving at a user level.

As illustrated in FIG. 5, the different application nodes 180 intercept the download triggering signal using a download triggering module 73 running thereon. In order to process the download triggering signal, the user 40 should be previously authenticated by the application node 180. The authentication process is carried out using a user authentication module 72 connected to an authentication database 144 and to the data network 60 (via an input/output unit 64).

The authentication process can be carried out in various ways (as will be illustrated hereinafter). Nonetheless, the user authentication module 72 receives identification information in connection with the alleged user and compares it with authentication information stored in the authentication database 144. If there is a match, the user authentication module 72 sends a successful authentication signal to the download triggering module 73 inducing it to process the received download triggering signal.

In case of a successful authentication, the download triggering module 73 processes the received download triggering signal in transmitting a successful authentication signal to the download request transmitting module. Upon reception of a successful authentication signal, the later 75 transmits, via the data network 60, a download request to the user account management server 92 requiring an authorization to download the user account information stored in the user account information database 52 comprised therein.

When the location of the user account management server 92 is not know a priori by the application nodes 180, the download triggering signal transmitted by the user 40 should comprise information allowing for locating the centralized user account management server 92 over the data network 60. When the data network is the Internet, the server location information could for example be an IP address or a domain name of the server 92.

As illustrated in FIG. 4, the user account management server 92 intercepts the transmitted download request using a download request receiving module 130 running thereon. In order to successfully process the received download request, the application node (from which the download request has been transmitted) is previously authenticated by the user account management server 92. The node authentication process is carried out using a node authentication module 124 connected to an authentication database 144 and to the data network 60 (via an input/output unit 118). The node authentication module 124 receives node identification information and compares it with authentication information stored in the authentication database 144. If there is a match, the node authentication module 124 sends a successful authentication signal to the download request receiving module 130 inducing it to process the received download request.

In case of a successful authentication, the download request receiving module 130 processes the received download request in transmitting a signal to the user account information uploading module 132 inducing it to extract the appropriate user account information from the user account information database 52 and to transmit it, via the data network 60, to the application node 180.

The application node 180 receives and downloads the user account information using a user account information downloading module 74 connected to the data network 60.

According to a second embodiment of the present invention, the delivering action is automatically triggered according to predefined triggering rules (and does not require a manual triggering by the user). The triggering rules are stored in a triggering rules database 140 that can be located either in the user terminal 30, in the application nodes 180 or in the user account management server 92.

As illustrated in FIG. 5, at the application node level, the automatic triggering process is carried out by a download triggering module 73 connected to the triggering rules database 140 and to the download request transmitting module 75. The download triggering module 73 inquires the triggering rules database 140, receives thereof the predefined triggering rules, and, as a function thereof, transmits a signal to the download request transmitting module inducing it to transmit a download request for downloading the user account information from the user account information database 52.

As illustrated in FIG. 4, at the user account management server 92 level, the triggering process is carried out by an upload triggering module 136 connected to a triggering rules database 140 and to a user account information uploading module 132. The upload triggering module 73 inquires the triggering rules database 140, receives thereof the predefined triggering rules, and, as a function thereof, transmits a signal to the user account information uploading module 132 inducing it to upload the user account information from the user account information database 52 to the application nodes 180.

The fourth step of the method consists of authenticating, at the node level, the user before processing the user account information 16 (see FIG. 1). The authentication process consists of approving that the user account information provided to be processed by the application nodes originates well from the alleged user.

The authenticating process can be carried out by transmitting an authentication request to the user and receiving a positive authentication response thereof before processing the user account information.

The authentication process can be carried out using a remote phone call instead of requiring manual authentication procedures.

The authenticating process can also be carried out by tracking an identity of the user terminal 38 from which the delivering of the account information has been initiated (or from which a management request signal has been sent to the application nodes inviting for downloading the information from the database) and by comparing the tracked user terminal identity to an authentic user terminal identity of that given user known a priori by the application nodes.

In the case where the data network 60 comprises a mobile phone network, the user terminal 38 can be a mobile phone, and the mobile phone identity can for instance be the mobile phone number.

In the case where the data network comprises the Internet, the user terminal 38 can be a computer terminal connected to the Internet, and the computer terminal identity can for instance be an IP address or a MAC address of the computer terminal.

The authentication process is carried out using a user authentication module 72 located in the application nodes 180, where the user authentication module 72 is connected to the authentication database 144 and to the data network 60 via the input/output unit 64.

Once the user is authenticated 16, the fifth step of the method consists of automatically processing, at the application nodes 180, the delivered user account information. The processing comprises creating or accessing and updating a corresponding user account using the delivered user account information 18.

As illustrated in FIG. 5, the action of creating or updating a user account is carried out at each node by a user account management module 76 connected to the application service 84. The user account management module 76 is further connected to the user account information downloading module 74 and to the user account information receiving module 68 for acquiring the user account information.

The automatic processing by the user account management module 76 of the delivered user account information dispenses the user of any manual procedures in order to create a new user account or in order to update a preexistent user account.

In a first embodiment of the invention, the user account information comprises information indicating, for each application service, if it is a case of a new user desiring to create a new user account in association with the application service, or if it is a case of an existent user desiring to update his user account using the delivered user account information.

In a second embodiment of the invention, the application node 180 is adapted to track the identity of the user terminal 38 from which the delivering of the account information has been initiated (or from which a management request signal has been sent to the application nodes inviting for downloading the information from the database), as it is the case for the authentication process. In this case, by tracking the identity of the user and by comparing the tracked user identity to a list of existent users stored a priori thereat, the application node 180 automatically determines if the given user is a new user or an existent one. If it is a new user, a new user account will be created using the delivered user account information. If it is an existent user, the delivered user account information will rather be used to update the existent user account.

In the case where the application services in question comprise user login protected application services, the user account information delivered to the application nodes would comprise login information associated therewith. The login information normally comprises a corresponding user name and password for each one of the login protected application services.

In this case, if the requested action is to create a new user account, the delivered login information would be used to set up the initial login information of the user, which would be used subsequently to access the user account. However, if the requested action is to update an existent user account, the delivered login information would rather be used to authenticate the user in order to access and update the user account.

The last step according to the invention is to notify the user if the processing (i.e. creating a user account or updating an existent user account) has been carried out successfully 20 (see FIG. 1). As illustrated in FIG. 5, the notification process is carried out using a notification module 80 located at the node level. The notification module 80 is connected to the user account management module 76 for receiving thereof a signal indicating if the user account has been updated successfully. The notification module 80 is further connected to the data network (via the input/output unit 64) for transmitting the notification signal to the user 40.

The notification process can be carried out by various communication methods, among others, by using a remote phone call, by sending a SMS message at the user's mobile device, by sending an email to the user or by any other communication method adapted to the data network in question.

As a further aspect of the invention, Referring to FIGS. 2 to 5, there is provided a system for managing a user related accounts associated with application services distributed over a data network.

At a basic level, the system comprises an information receiving module 44, a data transmission unit 48, a user account information database 52, and a user account management module 76. The information receiving module 44 is adapted for receiving node identification information allowing for identifying the application nodes storing the plurality of application services for which a user account management is required, and for receiving user account information in connection with the plurality of application services. In a preferred embodiment, the information is specified and transmitted by the user 40.

The user account management module 76 is for distribution and application at various application nodes. This module is adapted for enabling the application nodes to acquire and automatically process the user account information instead of requiring any manual procedures by the user. As mentioned hereinbefore, the processing comprises, for each one of the application services, creating or accessing and updating a corresponding user account using the user account information.

The data transmission unit 48 is adapted to be connected to the information receiving module 44 and to the data network 60. The data transmission unit 48 receives from the information receiving module 44 the user account information and the node identification information and uses the data network 60 for delivering thereon the user account information to the different application nodes storing the application services.

According to a first embodiment of the invention (see FIG. 3), the information receiving module 44, the data transmission unit 48 and the user account information database 52 are locally connected to a user terminal 38 associated with the user. Preferably, the delivering of the user account information to the application nodes is initiated by the user himself using a transmission triggering module 46 located in the user terminal 38.

The user terminal 38 could be any communication device adapted to transmit data over the data network 60. When the data network 60 comprises the Internet, the user terminal 38 could be a computer terminal adapted to be connected to the Internet. When the data network comprises a mobile phone network, the user terminal 38 could be a mobile phone adapted to be connected to the mobile phone network.

According to a second embodiment of the invention (see FIG. 4), there is provided a user account management server 92 geographically distant from the user 40 and connected to the data network 60. As illustrated in FIG. 5, the user account management server 92 comprises a user identification and authentication module 120, a node authentication module 124, a data receiving module 128, a data uploading module 132, a data transmission triggering module 136, a centralized user account information database 96, a triggering rule database 140 and an authentication database 144.

The user identification and authentication module 120 is connected to the communication unit 88 and to the authentication database 144 for receiving user authentication information transmitted by a user via the data network 60 and for authenticating the alleged identified user using information stored in the authentication database 144.

Once the alleged identified user is authenticated, the identification and authentication module 120 transmits a successful authentication signal to the data receiving module 128 inducing it to acquire the user account information transmitted by the user and to store it in the centralized user account information database 96, in connection with that particular identified user.

The delivering action of the user account information stored in the centralized user account information database 96 to the application nodes can be initiated in various ways. In a first embodiment, the delivering action is initiated at the node level by a data transmission triggering module 73 connected to a user account information downloading module 74 distributed in the application nodes. The data transmission triggering module 73 sends a triggering signal to the user account information downloading module 74 prompting it to transmit a downloading request to the centralized user account management server 92 for downloading therefrom the stored user account information in connection with the user.

The downloading request is received by a node authentication module 124 that authenticates the application node before addressing the request to a user account information uploading module 132 for executing the request. The user account information uploading module 132 is connected to the centralized user account information database 96 for extracting the user account information in connection with that particular user and for transmitting the extracted user account information to the authenticated application node.

In a second embodiment of the invention, the delivering action is initiated at the level of the centralized user account management server 96, by an upload triggering module located therein 136. According to a first example, the delivering action is initiated according to predefined triggering rules stored in the triggering rule database 140 connected to the upload triggering module 136. The triggering rules could for instance be on a temporal basis (ex. transmitting the user account information on a day basis). The upload triggering module 136 is connected to the user account information uploading module 132 and to the triggering rules database 140 for extracting the user account information and for transmitting it to the application nodes.

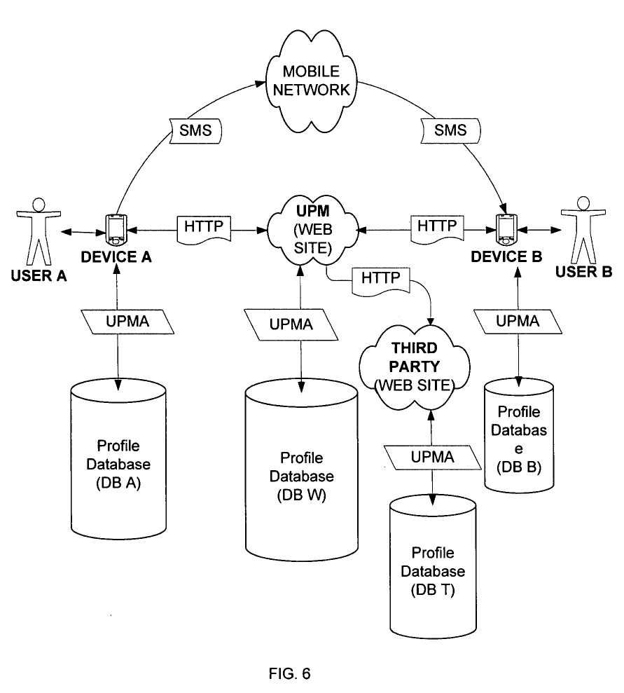

Referring to FIG. 6, there is provided a chart of sequential events that can be involved according to a first embodiment of updating a user related account information associated with application services distributed over a data network.

First, a first user (User A) edits his profile stored in a database (DB A) connected to a first device (Device A). Second, a universal profile management application (UPMA) stored in Device A generates a SMS profile from the database (DB A). Third, User A sends the SMS profile from Device A to Device B associated with a second user (User B). In the same time, the UPMA running on Device A submits a HTTP form through Internet to a universal profile management (UPM) site on which a UPMA runs. Fourth, the SMS is relayed to User B via a Mobile Company Network. Sixth, the SMS is received by User B (on Device B). In fact, the UPMA running on Device B intercepts the SMS sent by User A. From the other side, the UPMA running on the UPM site intercepts the HTTP requests, extracts the profile information and updates its profile database (DB W) with the User A's information. Seventh, the UPMA running on Device B updates the received User A information on Device B's database (DB B). The actual profile information can reside on the UPM site where UPMA (device B) can retrieve such information after receiving the SMS profile from User A (device A). Eighth, the UPMA (running on UPM site) submits an HTTP form to a Third Party site (running an UPMA) where User A has a profile information to be managed. Finally, the UPMA running on the third party site intercepts the HTTP form and updates the third party profile database (DB W) with the User A's information.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. A method for managing a user related account information, the method comprising:
receiving user account information for use in connection with at least one application service associated with said user for which a user account management is required;
receiving node identification information allowing for identifying at least one application node distributed over a data network, where said at least one application node stores said at least one application service;
using said received node identification information for delivering to said at least one application node, through said data network, said user account information; and
instead of requiring from said user any manual procedures, automatically processing, at said at least one application node, said delivered user account information, where said processing comprises, in connection with each one of said at least one application service, creating or accessing and updating a corresponding user account using said received user account information.

2. The method as claimed in claim 1 further comprising authenticating said user before processing said received user account information.

3. The method as claimed in claim 2, wherein said authenticating comprises transmitting an authentication request to said user and receiving a positive authentication response thereof before carrying out said processing.

4. The method as claimed in claim 3, wherein said authenticating is carried out using a remote phone call instead of requiring manual authentication procedures.

5. The method as claimed in claim 4 further comprising notifying said user if said processing has been carried out successfully.

6. The method as claimed in claim 5, wherein said notifying is carried out using a remote phone call.

7. The method as claimed in claim 1, wherein said at lest one application service comprises at least one user login protected application service, said received user account information comprises login information associated therewith, and said creating or accessing a corresponding user account is carried out using said login information.

8. The method as claimed in claim 7, wherein said login information comprises a corresponding user name and password of said user for each one of said at least one login protected application service.

9. The method as claimed in claim 8, wherein said user account information comprises user profile information comprising at least one of contact information and wallet information associated with said user.

10. The method as claimed in claim 1, wherein said data network comprises the Internet.

11. The method as claimed in claim 10, wherein said application services comprise Web application services, and said application nodes comprise application servers connected to the Internet storing said Web application services.

12. The method as claimed in claim 11, wherein said Web application services comprise user login protected Web application services, said provided user account information comprises login information associated with said login protected Web application services, and said creating or accessing a corresponding user account is carried out using said login information, where said login information comprises a corresponding user name and password of said user for each one of said login protected Web application services and said user account information comprises user profile information.

13. The method as claimed in claim 11, wherein said node identification information comprises domain names associated with said Web application services.

14. The method as claimed in claim 10, wherein said user account information is stored in a user account information database connected to the Internet from which said user account information is delivered to said at least one application node.

15. The method as claimed in claim 14, wherein said user account information database is locally connected to a user terminal associated with said user, said received node identification information is specified by said user, and said delivering said user account information to said at least one application node is initiated by said user using said user terminal.

16. The method as claimed in claim 15, wherein said user terminal is a computer terminal connected to the Internet.

17. The method as claimed in claim 15, wherein said network further comprises a mobile phone network, and said user terminal is a mobile phone connected to said mobile phone network and to the Internet.

18. The method as claimed in claim 17 further comprising authenticating said user before processing said delivered user account information and notifying said user if said processing has been carried out successfully.

19. The method as claimed in claim 18, wherein said authenticating and said notifying are carried out using a remote phone call.

20. The method as claimed in claim 18, wherein said authenticating comprises tracking, by said at least one application node, an identity of said mobile phone from which said delivering has been initiated and comparing said tracked mobile phone identity to an authentic mobile phone identity of said user.

21. The method as claimed in claim 20, wherein said mobile phone identity is a mobile phone number.

22. The method as claimed in claim 14, wherein said user account information database is comprised in a server connected to the Internet and geographically distant from said user.

23. The method as claimed in claim 22, wherein said delivering said user account information to said at least one application node is initiated by an upload triggering module located in said server.

24. The method as claimed in claim 22, wherein said delivering said user account information to said at least one application node is initiated by a download triggering module located at said at least one application node.

25. The method as claimed in claim 24, wherein said delivering is initiated by said download triggering module after receiving a download signal from said user inviting for downloading said user account information from said user account information database.

26. The method as claimed in claim 25, wherein said download signal comprises information allowing for locating said user account information database over the Internet.

27. The method as claimed in claim 26, wherein said information allowing for locating said user account database over the Internet is an IP address of said database.

28. The method as claimed in claim 1, wherein said data network comprises a mobile phone network, said application services comprise mobile application services, and said application nodes comprise mobile phone devices storing said mobile application services.

29. The method as claimed in claim 28 further comprising authenticating said user before processing said provided user account information and notifying said user if said processing has been carried out successfully.

30. The method as claimed in claim 29, wherein said authentication is carried out using a remote phone call instead of requiring manual authentication procedures and said notification is carried out using a remote phone call.

31. The method as claimed in claim 30, wherein said node identification information comprises phone numbers of said mobile phone devices storing said mobile application services.

32. A system for managing a user related account information, the system comprising:
an information receiving module for receiving node identification information allowing for identifying at least one application node storing at least one application service for which a user account management is required, and for receiving user account information in connection with said at least one application service;
a user account information database for storing said received user account information;
a data transmission unit adapted to be connected to said user account information database and to said network for delivering through said data network said user account information to said at least one application node storing said at least one application service; and
a user account management module for distribution and application at various application nodes comprising said at least one application node, for enabling said application nodes to acquire and automatically process said user account information instead of requiring any manual procedures by said user, where said processing comprises, for each one of said at least one application service, creating or accessing and updating a corresponding user account using said user account information.

33. The system as claimed in claim 32, wherein said data network comprises a mobile phone network, said application services comprise mobile application services, and said application nodes comprise mobile phone devices connected to the mobile network.

34. The system as claimed in claim 32 wherein said data network comprises the Internet.

35. The system as claimed in claim 34, wherein said application services comprise Web application services, and said application nodes comprise application servers connected to the Internet storing said Web application services.

36. The system as claimed in claim 35, wherein said Web application services comprise user login protected Web application services, said provided user account information comprises login information associated with said login protected Web application services, and said creating or accessing a corresponding user account is carried out using said login information, where said login information comprises a corresponding user name and password of said user for each one of said login protected Web application services and said user account information comprises user profile information comprising at least one of contact information and wallet information associated with said user.

37. The system as claimed in claim 32 further comprising a data transmission triggering module for initiating said delivering of said user account information from said user account information database to said at least one application node.

38. The system as claimed in claim 37, wherein said information receiving module, said data transmission triggering module, said data transmission unit and said user account information database are locally connected to a user terminal associated with said user, and said delivering said user account information to said at least one application node is initiated by said user using said data transmission triggering module.

39. The system as claimed in claim 38, wherein said user terminal is a computer terminal connected to the Internet.

40. The system as claimed in claim 38, wherein said data network further comprises a mobile phone network, and said user terminal is a mobile phone connected to said mobile phone network and to the Internet.

41. The system as claimed in claim 38 further comprising an authentication module for authenticating said user before processing said delivered user account information.

42. The system as claimed in claim 41 further comprising a notification module for transmitting a notification signal to said user indicating if said processing has been carried out successfully.

43. The system as claimed in claim 41, wherein said authentication module is adapted to be connected to said data network for transmitting an authentication request to said user for validating said processing, said authentication module being adapted to receive an authentication request response from said user.

44. The system as claimed in claim 43, wherein said authentication is carried out using a remote phone call.

45. The system as claimed in claim 41, wherein said authenticating comprises tracking an identity of said mobile phone from which said delivering has been initiated and comparing said tracked mobile phone identity to an authentic mobile phone identity of said user.

46. The system as claimed in claim 45, wherein said mobile phone identity is a mobile phone number.

47. The system as claimed in claim 32 further comprising a user account management server geographically distant from said user and connected to the Internet, wherein said data transmission unit and said user account information database are connected to said server.

48. The system as claimed in claim 47, wherein said user account management server comprises an upload triggering module for initiating said delivering and a user account information uploading module for uploading said user account information stored in said user account information database to said at least one application node.

49. The method as claimed in claim 48, wherein said upload triggering module is connected to a triggering rule database storing predefined triggering rules according to which said initiating is carried out.

50. The system as claimed in claim 48, wherein said delivering said user account information to said at least one application node is initiated at the node level by a download triggering module connected to download request transmitting module located in said at least one application node.

51. The system as claimed in claim 50, wherein said delivering is initiated by said download triggering module after receiving a download signal from said user inviting to download said user account information from said user account information database.

52. The system as claimed in claim 51, wherein said download signal transmitted by the user comprises information allowing for locating said user account information database over the Internet.

53. The system as claimed in claim 52, wherein said information allowing for locating said user account management server over the Internet is an IP address of said server.

54. The system as claimed in claim 53, wherein said login information comprises a corresponding user name and password of said user for each one of said login protected application services.

55. The system as claimed in claim 54 wherein said user account information comprises user profile information comprising at least one of contact information and wallet information associated with said user.
